(19) United States
(12) Patent Application Publication
(10) Pub. No.: US 2014/0183317 A1
(43) Pub. Date: Jul. 3, 2014

(54) MOUNTING DEVICE FOR EXPANSION CARD

(71) Applicants: HON HAI PRECISION INDUSTRY CO., LTD., New Taipei (TW); HONG FU JIN PRECISION INDUSTRY (Shenzhen) Co., LTD, Shenzhen (CN)

(72) Inventor: ZHAN-YANG LI, Shenzhen (CN)

(73) Assignees: HON HAI PRECISION INDUSTRY CO., LTD., New Taipei (TW); HONG FU JIN PRECISION INDUSTRY (Shenzhen) Co., LTD, Shenzhen (CN)

(21) Appl. No.: 14/076,144

(22) Filed: Nov. 8, 2013

(30) Foreign Application Priority Data
Jan. 3, 2013 (CN) 2013100001160

(51) Int. Cl. G06F 1/18

(52) U.S. Cl. CPC G06F 1/185
USPC 248/316.7

(57) ABSTRACT

A mounting device for an expansion card includes a chassis, a supporting member, a resilient member, and a locking member. The chassis includes a bracket. A sliding way is defined in the bracket. The supporting member is located in the bracket and is movable in the sliding way. The resilient member is located between the bracket and the supporting member. The locking member is pivotally mounted to the supporting member. The supporting member is configured to be driven by the resilient member to push the locking member towards the expansion card, and the locking member is pivotable relative to the supporting member to engage the expansion card.

### BACKGROUND

1. Technical Field

The present disclosure relates to a mounting device for retaining expansion cards in a computer chassis.

2. Description of Related Art

A computer system usually includes expansion cards, such as PCI card, graphics cards, for example, for enhancing capabilities of the computer system. The expansion cards are often fastened in the computer system with screws at one side. However, installing screws to fix the expansion cards is very laborious and time-consuming, and only one side of the expansion card fastens making the expansion card unstable. Therefore, there is room for improvement within the art.

### BRIEF DESCRIPTION OF THE DRAWINGS

FIG. 1 is an exploded, isometric, and cutaway view of one embodiment of partially a mounting device for an expansion card.

FIG. 2 is an isometric view of a supporting member of the mounting device of FIG. 1.

FIG. 3 is an isometric view of a locking member of the mounting device of FIG. 1.

FIG. 4 is an assembled, cutaway view of the mounting device of FIG. 1.

FIG. 5 is a similar to FIG. 4, but shown from another aspect and the rotating member is in a disengaging state.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

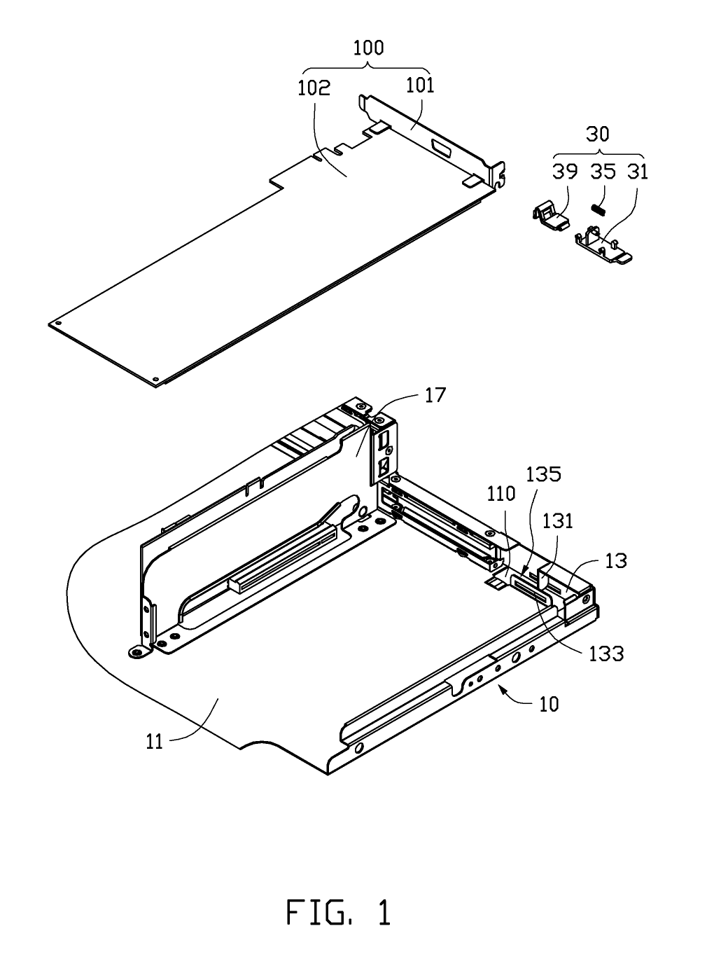

FIG. 1 shows one embodiment of a mounting device for an expansion card 100. The mounting device includes a chassis 10 and a mounting assembly 30. The chassis 10 includes a bottom wall 11, a bracket 13, and a riser card 17. The bracket 13 defines a sliding way 135. A pair of sliding slots 133 is defined in the bracket 13 on opposite sides of the sliding way 135. An opening 110 is defined in the bottom wall 11 adjacent to the bracket 13. A blocking tab 131 protrudes into the sliding way 135. The expansion card 100 includes a printed circuit board 102 and a baffle 101.

The mounting assembly 30 includes a supporting member 31, a locking member 39, and a resilient member 35.

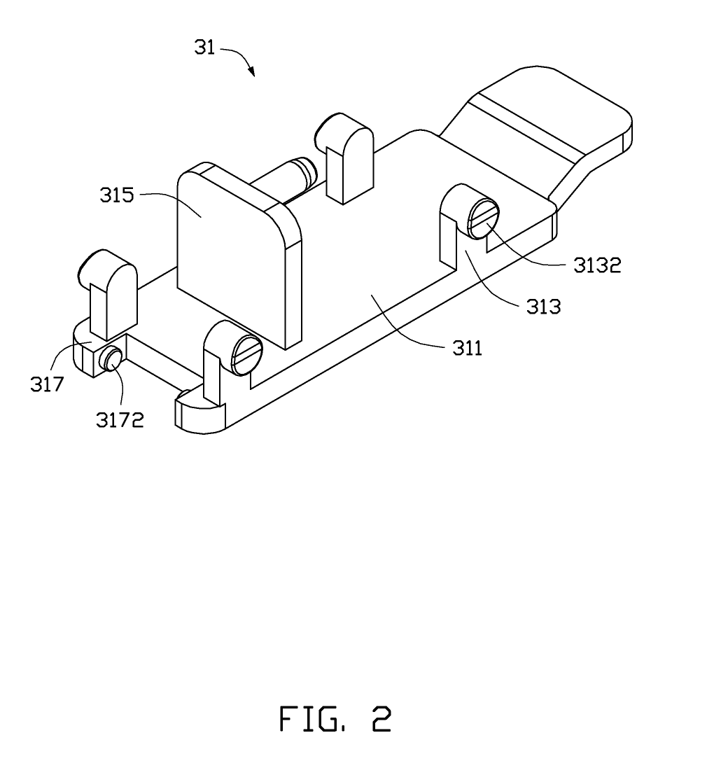

FIG. 2 illustrates an enlarged view of the supporting member 31. The supporting member 31 includes a supporting board 311, four sliding portions 313, a driving board 315, and a pair of pivot portions 317. A sliding tab 3132 protrudes from each sliding portion 313 to engage with each sliding slot 133. The driving board 315 is substantially perpendicular to the supporting board 311. A pivot pin 3172 protrudes from each pivot portion 317.

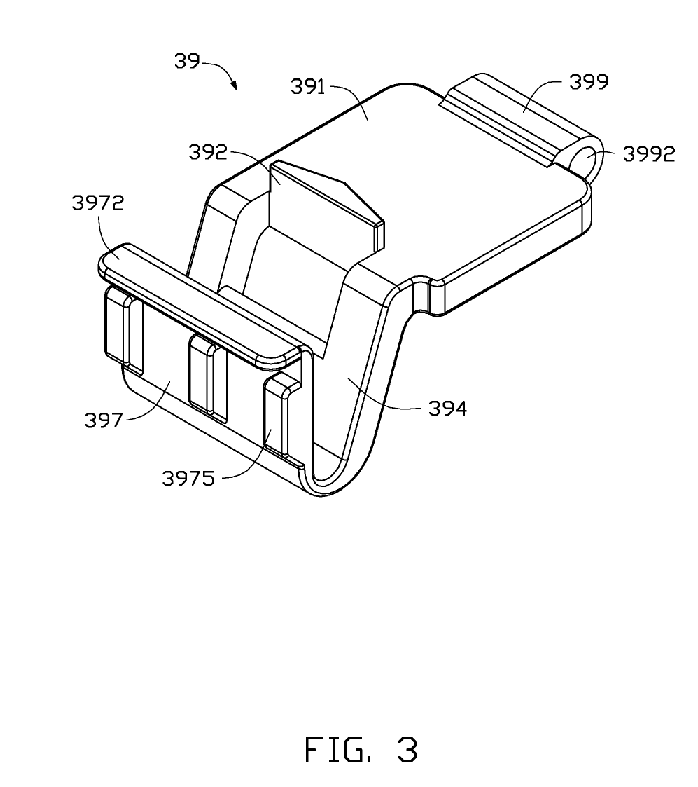

FIG. 3 illustrates an enlarged view of the locking member 39. The locking member 39 includes a fixing board 391, rotating portion 399, a connecting portion 394, and a locking portion 397. A handle 392 extends from the fixing board 391. The connecting portion 394 connects the fixing board 391 to the locking portion 397. An extending direction of the handle 392 is substantially opposite to an extending direction of the connecting portion 394. The rotating portion 399 is located on one side of the fixing board 391. Two pivot recesses 3992 are defined on opposite ends of the rotating portion 399 to engage with each pivot pin 3172. The connecting portion 394 is resilient and is oblique to the locking portion 397 and the fixing board 391. A cross-section of the locking portion 397 combining with the connecting portion 394 is substantially V-shaped. In an original state, the locking portion 397 is substantially perpendicular to the fixing board 391. A stop flange 3972 extends from a distal end of the locking portion 397. A plurality of engaging tabs 3975 protrudes from the locking portion 397. The plurality of engaging tabs 3975 is substantially parallel.

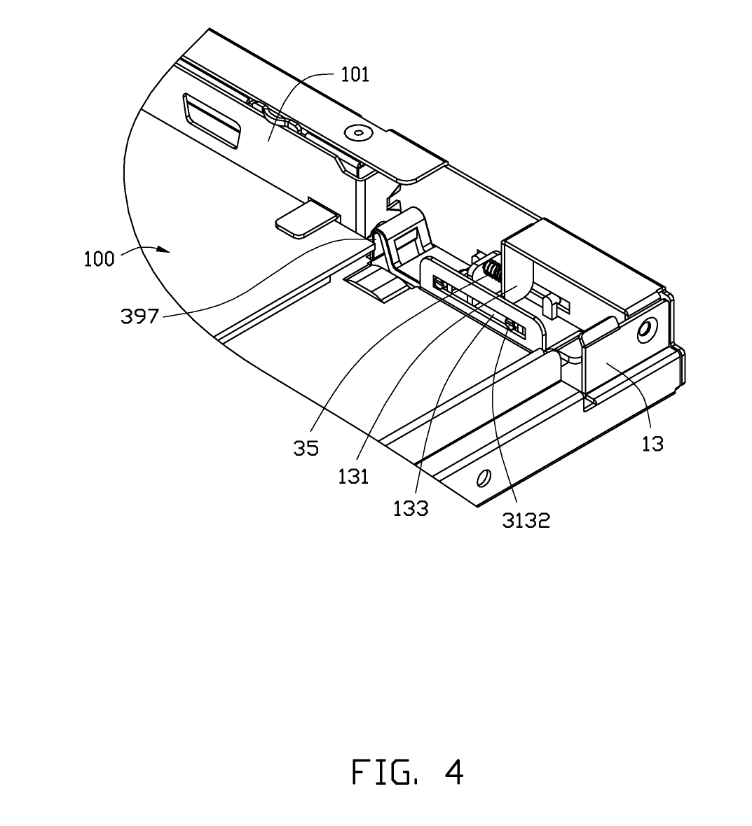

FIG. 4 illustrates an assembled, cutaway view of the chassis 10, the mounting assembly 30 and the expansion card 100. In assembly, the expansion card 100 is plugged with the riser card 17. The supporting member 31 is positioned in the sliding way 135. The sliding tabs 3132 slide in the sliding slots 133 of the bracket 13. The locking member 39 is pivotally mounted to the supporting member 31. The resilient member 35 is located between the driving board 315 and the blocking tab 131. The supporting member 31 is moveable in the sliding way 135 along a substantially straight direction driven by the resilient member 35.

To secure the expansion card 100, the locking member 39 is rotated relative to the supporting member 31 to an engaging state. The resilient member 35 pushes the supporting member 31 and the locking member 39 towards the expansion card 100. The locking member 39 abuts and engages the baffle 101 of the expansion card 100 to the bracket 13.

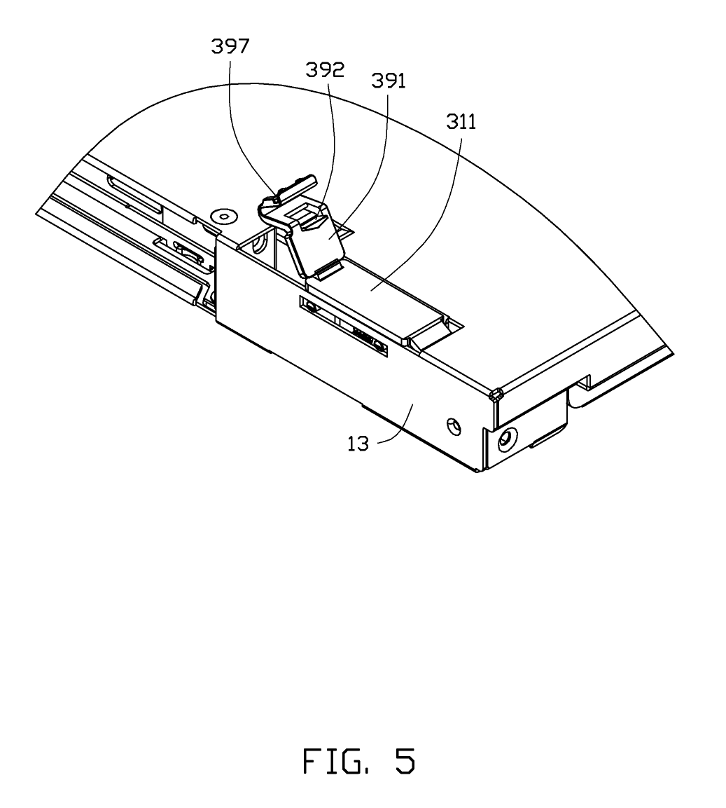

FIG. 5 illustrates a disengaging state of the locking member 39. To disengage the expansion card 100 from the bracket 13, the locking member 39 is rotated from the engaging state to the disengaging state. The locking member 39 is rotated from an inner side of the bracket 13 to an outer side of the bracket 13 through the opening 110. The expansion card 100 is disengaged from the chassis 10.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mounting device for an expansion card comprising:
a chassis comprising a bracket, and a sliding way is defined in the bracket;
a supporting member located in the bracket and being movable in the sliding way;
a resilient member located between the bracket and the supporting member; and
a locking member pivotally mounted to the supporting member;
wherein the supporting member is configured to be driven by the resilient member to push the locking member towards the expansion card, and the locking member is pivotable relative to the supporting member to engage the expansion card.

2. The mounting device of claim 1, wherein the locking member comprises a locking portion and a connecting portion connected to the locking portion, and the connecting portion is configured to be resilient deformed.

3. The mounting device of claim 2, wherein a cross-section of the connecting portion combining with the locking portion is substantially V-shaped.

4. The mounting device of claim 2, wherein the locking member comprises a fixing board, a handle protrudes from the fixing board, and an extending direction of the handle is substantially opposite to an extending direction of the connecting portion.

5. The mounting device of claim 4, wherein the supporting member comprises a driving board to engage with the resilient member, and the driving board is substantially parallel to the fixing board when the locking member locks the expansion card.

6. The mounting device of claim 5, wherein the driving board is substantially perpendicular to the fixing board.

7. The mounting device of claim 4, wherein a moving direction of the supporting member is substantially parallel to the fixing board.

8. The mounting device of claim 2, wherein the locking portion comprises a plurality of engaging tabs, and the plurality of engaging tabs is resilient and is substantially parallel to each other.

9. The mounting device of claim 2, wherein the locking member comprises a rotating portion, the supporting member comprises a pair of pivot pins, and the pair of pivot pins is engaged with the rotating portion.

10. The mounting device of claim 1, wherein the supporting member is slidable in the sliding way along a substantially straight direction.

11. A mounting device for an expansion card comprising:
a chassis comprising a bracket, and an opening is defined in the bracket;
a supporting member located in the bracket at a first side of the bracket;
a resilient member located between the bracket and the supporting member; and
a locking member pivotally mounted to the supporting member and rotatable from the first side of the bracket to a second side of the bracket through the opening, and the second side of the bracket being opposite to the first side of the bracket,
wherein the supporting member is configured to push the locking member towards the expansion card driven by the resilient member, and the locking member is pivotable relative to the supporting member to engage the expansion card.

12. The mounting device of claim 11, wherein the locking member comprises a locking portion and a connecting portion connected to the locking portion, and the connecting portion is configured to be resilient deformed.

13. The mounting device of claim 12, wherein a cross-section of the connecting portion combining with the locking portion is substantially V-shaped.

14. The mounting device of claim 12, wherein the locking member comprises a fixing board, a handle protrudes from the fixing board, and an extending direction of the handle is substantially opposite to an extending direction of the connecting portion.

15. The mounting device of claim 14, wherein the supporting member comprises a driving board to engage with the resilient member, and the driving board is substantially parallel to the fixing board when the locking member locks the expansion card.

16. The mounting device of claim 15, wherein the driving board is substantially perpendicular to the fixing board.

17. The mounting device of claim 14, wherein a moving direction of the supporting member is substantially parallel to the fixing board.

18. The mounting device of claim 12, wherein the locking portion comprises a plurality of engaging tabs, and the plurality of engaging tabs is resilient and is substantially parallel to each other.

19. The mounting device of claim 12, wherein the locking member comprises a rotating portion, the supporting member comprises a pair of pivot pins, and the pair of pivot pins is engaged with the rotating portion.

20. The mounting device of claim 11, wherein the supporting member is slidable in the bracket along a substantially straight direction.
